(19) United States
(12) Patent Application Publication
(10) Pub. No.: US 2025/0191289 A1
(43) Pub. Date: Jun. 12, 2025

(54) INFORMATION PROCESSING SYSTEM, INFORMATION PROCESSING METHOD, AND STORAGE MEDIUM

(71) Applicant: NEC Corporation, Minato-ku, Tokyo (JP)

(72) Inventors: Takashi NONAKA, Tokyo (JP); Kiri Inayoshi, Tokyo (JP); Kentaro NISHIDA, Tokyo (JP)

(73) Assignee: NEC Corporation, Minato-ku, Tokyo (JP)

(21) Appl. No.: 18/843,800

(22) PCT Filed: Mar. 15, 2022
(86) PCT No.: PCT/JP2022/011475

§ 371 Date: Sep. 4, 2024

(51) Int. Cl. G06T 17/00; G06F 3/01

(52) U.S. Cl. CPC G06T 17/00; G06F 3/013

(57) ABSTRACT

In order to solve an object that is to present information which makes it possible to more sufficiently ascertain a task carried out by a user in a virtual space, an information processing system (1) includes: a task information acquisition unit (11) which acquires task information that is related to a task carried out by a user in a virtual space; a line-of-sight information acquisition unit (12) which acquires line-of-sight information that is related to a line of sight of the user; an emotion information acquisition unit (13) which acquires emotion information that is related to an emotion of the user; and a relevance information output unit (14) that outputs information indicating relevance between a change in the task information, a change in the line-of-sight information, and a change in the emotion information, which are associated with a progress of the task.

### TECHNICAL FIELD

The present invention relates to a technology for presenting information that is acquired when a user carries out a task in a virtual space.

### BACKGROUND ART

There has been known a technology for presenting information that is acquired when a user carries out a task in a virtual space. For example, Patent Literature 1 discloses an apparatus that constructs a training environment in a virtual space, and that, when a trainee (user) carries out a training action (task), sequentially records, together with time, position coordinates, action, and speech of the trainee in the virtual space, and stores, as training data, the coordinates, the action and the speech together with the time. Further, this apparatus replicates a past training condition by retrieval and reproduction of the training data that has been stored.

### CITATION LIST

### Patent Literature

### Patent Literature 1

Japanese Patent Application Publication Tokukai No. 2002-366021

### SUMMARY OF INVENTION

### Technical Problem

In the apparatus disclosed in Patent Literature 1, there has been a problem in that the training action of the trainee (the task carried out by the user) cannot be sufficiently ascertained merely by replication of the past training condition.

An example aspect of the present invention is attained in view of the above problem, and an example object of an aspect of the present invention is to provide a technology for presenting information that makes it possible to more sufficiently ascertain a task which is carried out by a user in a virtual space.

### Solution to Problem

An information processing system according to an aspect of the present invention includes: a task information acquisition means which acquires task information that is related to a task carried out by a user in a virtual space; a line-of-sight information acquisition means which acquires line-of-sight information that is related to a line of sight of the user; an emotion information acquisition means which acquires emotion information that is related to an emotion of the user; and a relevance information output means that outputs information indicating relevance between a change in the task information, a change in the line-of-sight information, and a change in the emotion information, which are associated with a progress of the task.

An information processing method according to an aspect of the present invention includes: acquiring task information that is related to a task carried out by a user in a virtual space; acquiring line-of-sight information that is related to a line of sight of the user; acquiring emotion information that is related to an emotion of the user; and outputting information indicating relevance between a change in the task information, a change in the line-of-sight information, and a change in the emotion information, which are associated with a progress of the task.

A program according to an aspect of the present invention is a program for causing a computer to function as an information processing system, the program causing the computer to function as: a task information acquisition means which acquires task information that is related to a task carried out by a user in a virtual space; a line-of-sight information acquisition means which acquires line-of-sight information that is related to a line of sight of the user; an emotion information acquisition means which acquires emotion information that is related to an emotion of the user; and a relevance information output means that outputs information indicating relevance between a change in the task information, a change in the line-of-sight information, and a change in the emotion information, which are associated with a progress of the task.

### Advantageous Effects of Invention

An example aspect of the present invention can present information that makes it possible to more sufficiently ascertain a task which is carried out by a user in a virtual space.

### BRIEF DESCRIPTION OF DRAWINGS

FIG. 1 is a block diagram illustrating a configuration of an information processing system according to a first example embodiment of the present invention.

FIG. 2 is a flowchart illustrating a flow of an information processing method according to the first example embodiment of the present invention.

FIG. 3 is a diagram schematically illustrating an overview of an information processing system according to a second example embodiment of the present invention.

FIG. 4 is a block diagram illustrating a configuration of an information processing system according to the second example embodiment of the present invention.

FIG. 5 is a diagram illustrating an example of content data that is referred to in the second example embodiment of the present invention.

FIG. 6 is a diagram illustrating an example of a task progress database that is referred to in the second example embodiment of the present invention.

FIG. 7 is a flowchart illustrating a flow of an information processing method according to the second example embodiment of the present invention.

FIG. 8 is a diagram illustrating a specific example of an analysis result that is displayed by a terminal in the second example embodiment of the present invention.

FIG. 9 is a diagram illustrating another specific example of the analysis result that is displayed by the terminal in the second example embodiment of the present invention.

FIG. 10 is a block diagram illustrating a configuration of an information processing system according to a third example embodiment of the present invention.

FIG. 11 is a diagram schematically illustrating an example of a virtual space according to the third example embodiment of the present invention.

FIG. 12 is a diagram illustrating an example of content data that is referred to in the third example embodiment of the present invention.

FIG. 13 is a flowchart illustrating a flow of an information processing method according to the third example embodiment of the present invention.

FIG. 14 is a diagram illustrating a specific example of an analysis result that is displayed by a terminal in the third example embodiment of the present invention.

FIG. 15 is a flowchart illustrating a flow of an information processing method according to a first variation of the third example embodiment of the present invention.

FIG. 16 is a flowchart illustrating a flow of an information processing method according to a second variation of the third example embodiment of the present invention.

FIG. 17 is a block diagram illustrating an example of a hardware configuration of each of apparatuses constituting an information processing system according to each example embodiment of the present invention.

### DESCRIPTION OF EMBODIMENTS

### First Example Embodiment

The following description will discuss in detail a first example embodiment of the present invention, with reference to drawings. The present example embodiment is a basic form of example embodiments described later.

### (Configuration of Information Processing System 1)

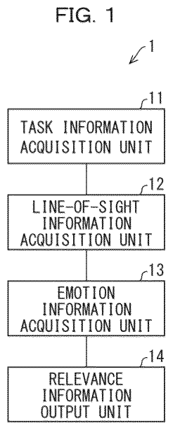

The following will describe a configuration of an information processing system 1 according to the present example embodiment, with reference to FIG. 1. FIG. 1 is a block diagram illustrating a configuration of the information processing system 1. As illustrated in FIG. 1, the information processing system 1 includes a task information acquisition unit 11, a line-of-sight information acquisition unit 12, an emotion information acquisition unit 13, and a relevance information output unit 14. The task information acquisition unit 11 is an example of a configuration that realizes a task information acquisition means recited in claims. The line-of-sight information acquisition unit 12 is an example of a configuration that realizes a line-of-sight information acquisition means recited in claims. The emotion information acquisition unit 13 is an example of a configuration that realizes an emotion information acquisition means recited in claims. The relevance information output unit 14 is an example of a configuration that realizes a relevance information acquisition means recited in claims.

The task information acquisition unit 11 acquires task information that is related to a task which is carried out by a user in a virtual space. The line-of-sight information acquisition unit 12 acquires line-of-sight information that is related to a line of sight of the user. The emotion information acquisition unit 13 acquires emotion information that is related to an emotion of the user. The relevance information output unit 14 outputs information indicating relevance between a change in the task information, a change in the line-of-sight information, and a change in the emotion information, which are associated with a progress of the task. Details of each of these functional blocks will be described below in the section “Flow of information processing method S1”.

### <Flow of Information Processing Method S1>

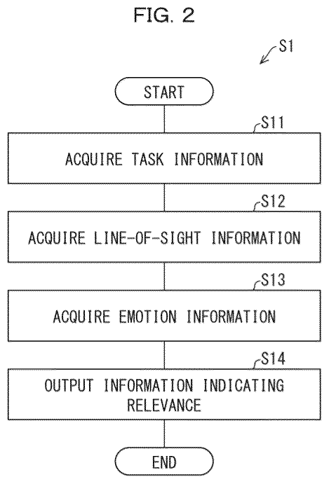

The information processing system 1 configured as described above carries out an information processing method S1 according to the present example embodiment. The following description will discuss a flow of the information processing method S1 with reference to FIG. 2. FIG. 2 is a flowchart showing a flow of the information processing method S1. As illustrated in FIG. 2, the information processing method S1 includes steps S11 through S14.

In step S11, the task information acquisition unit 11 acquires task information that is related to a task which is carried out by a user in a virtual space. For example, the task information may include, but is not limited to, information indicating start, end, or type of the task. Further, for example, the task information acquisition unit 11 may acquire the task information on the basis of an operation that is carried out by the user in the virtual space. Furthermore, the task information acquisition unit 11 may acquire the task information by referring to information that is associated with a task that can be carried out by the user in the virtual space. However, a method of acquiring the task information is not limited thereto.

In step S12, the line-of-sight information acquisition unit 12 acquires line-of-sight information that is related to a line of sight of the user. Here, for example, the line-of-sight information acquisition unit 12 may acquire the line-of-sight information on the basis of orientation of a virtual reality device that is worn by the user in order to carry out a task in the virtual space. Further, for example, the line-of-sight information acquisition unit 12 may acquire the line-of-sight information by referring to a captured image that includes a user as a subject. However, a method of acquiring the line-of-sight information is not limited thereto.

In step S13, the emotion information acquisition unit 13 acquires emotion information that is related to an emotion of the user. Here, for example, the emotion information can be acquired with use of a known emotion recognition technology. Examples of the emotion recognition technology include a technology according to which a physiological index of a user is analyzed and emotion information such as a concentration level or a stress level is acquired. Further, examples of the physiological index of a user include pulse waves, brain waves, heart rates, and perspiration. However, the emotion recognition technology is not limited thereto.

Processes of steps S11 to S13 are repeatedly carried out at each elapsed time point of a task, for example, while the user is carrying out the task in the virtual space. For example, the information processing system 1 stores, in a memory, the task information, the line-of-sight information, and the emotion information, which are acquired in steps S11 to S13, in association with an elapsed time point at which the information is acquired. Note that the memory may be inside or outside the information processing system 1.

In step S14, the relevance information output unit 14 outputs information indicating relevance between a change in the task information, a change in the line-of-sight information, and a change in the emotion information, which are associated with a progress of the task. Here, for example, the relevance information output unit 14 may output, as the information indicating the relevance, the task information, the line-of-sight information, and the emotion information in an aspect in which these pieces of information are associated with each other with respect to an elapsed time point. Examples of such an aspect include an aspect in which a graph that indicates a change in the task information, a graph that indicates a change in the line-of-sight information, and a graph that indicates a change in related information, with respect to a horizontal axis (or vertical axis) that represents elapsed time, are superimposed on each other by sharing the horizontal axis (or vertical axis). However, the information indicating relevance is not limited thereto.

### <Implementation Example by Program>

In case where the information processing system 1 is configured by a computer, the following program is stored in a memory that is referred to by the computer. The program is a program for causing a computer to function as the information processing system 1, the program causing the computer to function as: a task information acquisition means which acquires task information that is related to a task carried out by a user in a virtual space; a line-of-sight information acquisition means which acquires line-of-sight information that is related to a line of sight of the user; an emotion information acquisition means which acquires emotion information that is related to an emotion of the user; and a relevance information output means that outputs information indicating relevance between a change in the task information, a change in the line-of-sight information, and a change in the emotion information, which are associated with a progress of the task.

### Example Advantage of Present Example Embodiment

As described above, the information processing system 1, the information processing method S1, and the program according to the present example embodiment each employ a configuration which acquires task information that is related to a task carried out by a user in a virtual space; a configuration which acquires line-of-sight information that is related to a line of sight of the user; a configuration which acquires emotion information that is related to an emotion of the user; and a configuration that outputs information indicating relevance between a change in the task information, a change in the line-of-sight information, and a change in the emotion information, which are associated with a progress of the task.

Therefore, by using the present example embodiment, it is possible to know the relevance between a change in the task information, a change in the line-of-sight information, and a change in the emotion information, which are associated with a progress of a task carried out by a user in a virtual space. Thus, it is possible to more sufficiently ascertain the task that is carried out by the user. In this way, the present example embodiment can present information that makes it possible to more sufficiently ascertain a task which is carried out by a user in a virtual space.

### Second Example Embodiment

The following description will discuss in detail a second example embodiment of the present invention, with reference to drawings. Note that components having the same functions as those described in the first example embodiment are denoted by the same reference numerals, and descriptions thereof will be omitted accordingly.

### (Overview of Information Processing System 1A)

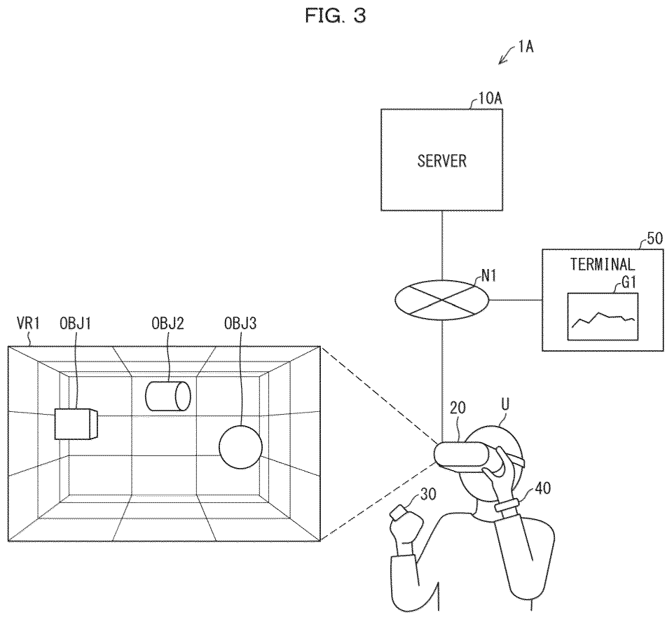

The following will describe an overview of an information processing system 1A according to the present example embodiment, with reference to FIG. 3. FIG. 3 is a diagram schematically illustrating the overview of the information processing system 1A. As illustrated in FIG. 3, the information processing system 1A is a system that analyzes, by a server 10A, a progress of a task that is carried out by a user U in a virtual space VR1, and displays an analysis result G1 on a terminal 50. Note that although FIG. 3 shows a single user U, the information processing system 1A can analyze a progress of a task that is carried out by each of a plurality of users U.

The virtual space VR1 is displayed on a head-mounted display (hereinafter, “HMD”) 20 that is worn by the user U. This allows the user U to experience virtual reality as if he/she were present in the virtual space VR1.

In an example of FIG. 3, the virtual space VR1 includes objects OBJ1, OBJ2, and OBJ3 as target objects of a task. The objects OBJ1, OBJ2, and OBJ3 are each a virtual object that is displayed in the virtual space VR1. Hereinafter, when these objects need not be specifically distinguished from each other, the objects are also simply described as “object OBJ”.

While wearing the HMD 20 and a sensor 40, the user U carries out a task in the virtual space VR1 by operating an operation device 30. The task that is carried out by the user U in the virtual space VR1 includes an operation with respect to each of the objects OBJs. In other words, the user U can carry out a plurality of tasks in the virtual space VR1. For example, the operation with respect to an object OBJ may be to cause, by operating the operation device 30, a pointer object (not shown) displayed in the virtual space VR1 to be displayed at a position of the object OBJ. Further, for example, the operation with respect to an object may be to bring the position of the operation device 30 in the virtual space VR1 closer to the position of the object OBJ so that the operation device 30 and the object OBJ are virtually brought into contact with each other. However, the operation with respect to the object OBJ is not limited to the above examples, but may be another operation(s).

The server 10A analyzes, on the basis of an orientation of the HMD 20, sensor information from the sensor 40, and operation information from the operation device 30, relevance between a change in task information, a change in line-of-sight information, and a change in emotion information, which are associated with a progress of the task. Then, the server 10A displays the analysis result G1 on the terminal 50. The analysis result G1 is an example of “information indicating relevance” recited in claims. This allows the information processing system 1A to present information that makes it possible to more sufficiently ascertain a task which is carried out by the user U in the virtual space VR1.

### (Configuration of Information Processing System 1A)

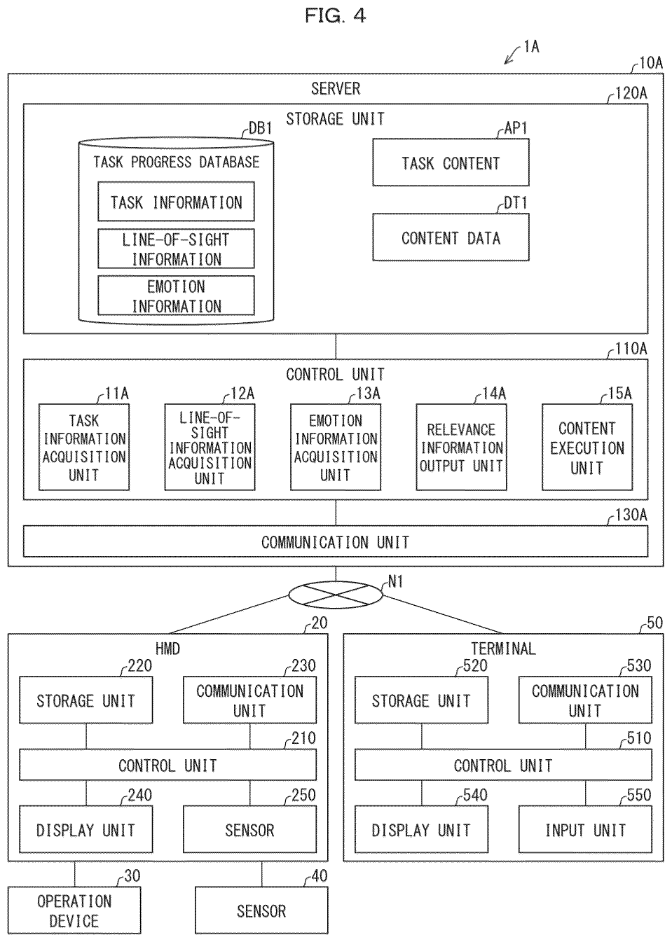

The following will describe a configuration of an information processing system 1A according to the present example embodiment, with reference to FIG. 4. FIG. 4 is a block diagram illustrating a configuration of the information processing system 1A. As illustrated in FIG. 4, the information processing system 1A includes a server 10A, an HMD 20, an operation device 30, a sensor 40, and a terminal 50.

The server 10A is connected to each of the HMD 20 and the terminal 50 via a network N1. The network N1 is constituted by, for example, a wireless local area network (LAN), a wired LAN, a wide area network (WAN), a public network, a mobile data communication network, another network, or a combination of some or all of these networks. The HMD 20 is connected with each of the operation device 30 and the sensor 40 so as to be capable of communicating with each of the operation device 30 and the sensor 40. For example, the HMD 20 may be connected with the operation device 30 and the sensor 40 by short-range wireless communication. Note that although FIG. 4 shows one HMD 20 and one terminal 50, the number of HMDs 20 connected to the server 10A and the number of terminals 50 connected to the server 10A are not limited thereto. Further, although one operation device 30 and one sensor 40 are illustrated, the number of operation devices 30 connected to the HMD 20 and the number of sensors 40 connected to the HMD 20 are not limited thereto.

### (Configuration of Server 10A)

The server 10A is a computer that analyzes a progress of a task of the user U in a virtual space VR1. The configuration of the server 10A will be described with reference to FIG. 4. As illustrated in FIG. 4, the server 10A includes a control unit 110A, a storage unit 120A, and a communication unit 130A. The control unit 110A carries out overall control of units of the server 10A. The storage unit 120A stores various data that is to be used by the control unit 110A. The communication unit 130A transmits and receives data to and from another apparatus under the control of the control unit 110A.

The control unit 110A includes a task information acquisition unit 11A, a line-of-sight information acquisition unit 12A, an emotion information acquisition unit 13A, a relevance information output unit 14A, and a content execution unit 15A. The task information acquisition unit 11A acquires task information indicating a task that is carried out by the user U among a plurality of tasks that can be carried out in the virtual space VR1. The task information acquisition unit 11A acquires the task information on the basis of operation information indicating an operation on the operation device 30. The line-of-sight information acquisition unit 12A acquires the line-of-sight information on the basis of the orientation of the HMD 20. The emotion information acquisition unit 13A acquires the emotion information on the basis of sensor information from measurement by the sensor 40. The relevance information output unit 14A outputs an analysis result G1. The analysis result G1 includes a graph that indicates a change in the emotion information with respect to an elapsed time of the task, and the task information or the line-of-sight information that was acquired at any elapsed time point indicated in the graph. The content execution unit 15A generates a virtual space VR1 that allows the user U to carry out the task therein. The content execution unit 15A is an example of a configuration that realizes a virtual space generation means recited in claims. Details of each unit included in the control unit 110A will be described below in the section “Flow of information processing method S1A”.

Further, as illustrated in FIG. 4, the various data stored in the storage unit 120A include task content AP1, content data DT1, and a task progress database DB1.

### (Task Content AP1)

The task content AP1 is an application program for providing a work environment in the virtual space VR1 to the user U. By the task content AP1 being executed by the content execution unit 15A, the work environment is provided to the user U. Hereinafter, a task that can be carried out in the work environment is also described as a “task included in task content AP1”. Further, the description that provision of the work environment to the user U is started is also described as “the user U starts task content AP1”. Further, the description that the user U carries out a task in the work environment is also described as “the user U carries out task content AP1”.

### (Content Data DT1)

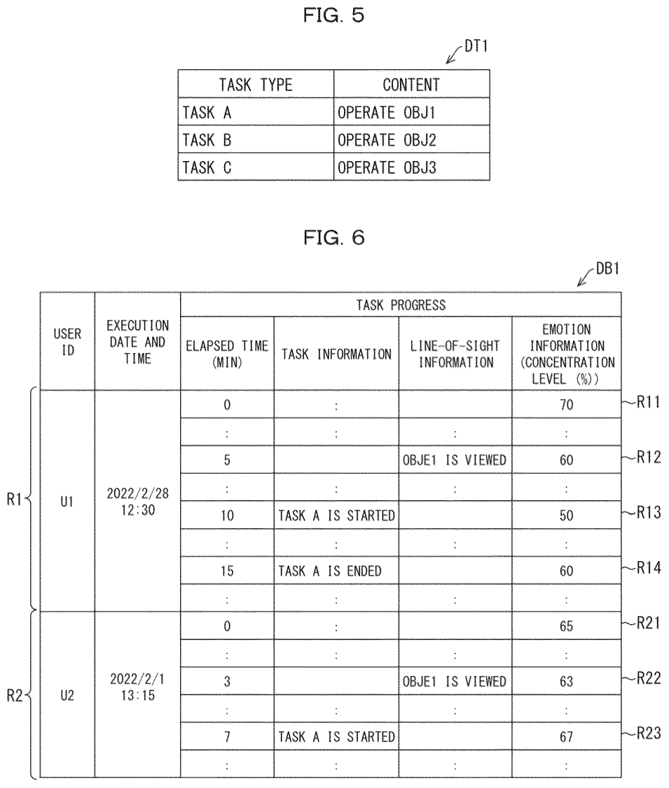

The content data DT1 is data that is referred to when the content execution unit 15A executes the task content AP1. The following description will discuss an example of the content data DT1 with reference to FIG. 5. FIG. 5 is a diagram illustrating an example of the content data DT1. As illustrated in FIG. 5, the content data DT1 includes information indicating the type and content of a task. Hereinafter, tasks whose task types are “A”, “B”, and “C” may be referred to as task A, task B, and task C, respectively. The task A is a task to operate the object OBJ1. The task B is a task to operate the object OBJ2. The task C is a task to operate the object OBJ3. The task A, the task B, and the task C are included in the task content AP1. By referring to the content data DT1, the content execution unit 15A can determine that the task A was carried out in a case where, for example, an operation with respect to the object OBJ1 was carried out. Note that information included in the content data DT1 is not limited to the example described above.

### (Task Progress Database DB1)

The task progress database DB1 stores, for each user U, task information, line-of-sight information, and emotion information that were acquired at each elapsed time point of a task. The following description will discuss an example of the task progress database DB1 with reference to FIG. 6. FIG. 6 is a diagram illustrating an example of the task progress database DB1. As illustrated in FIG. 6, the task progress database DB1 includes a user ID, execution date and time, an elapsed time, task information, line-of-sight information, and emotion information (in this example, a concentration level). Hereinafter, a user U having a user ID of “U1” may be referred to as a user U1 and a user U having a user ID of “U2” may be referred to as a user U2. The task progress database DB1 includes a record group R1 that is related to the user U1 and a record group R2 that is related to the user U2. In other words, the task information includes task information that is related to a plurality of users U1 and U2. Further, the emotion information includes emotion information that is related to a plurality of users U1 and U2. Further, the line-of-sight information includes line-of-sight information that is related to the plurality of users U1 and U2. Details of the record groups R1 and R2 will be described below in the section “Flow of information processing method S1A”. Note that information and a data structure thereof, which are stored in the task progress database DB1, are not limited to the above-described examples.

### (Task Information)

The task information includes information indicating start, end, or type of a task. In the example of FIG. 6, the task information “START OF TASK A” included in records R13 and R23 includes information indicating the start of the task and the type “A” of the task. Further, the task information “END OF TASK A” included in a record R14 includes information indicating the end of the task and the type “A” of the task.

### (Line-of-Sight Information)

The line-of-sight information includes information indicating a virtual object OBJ which is disposed on a line of sight of the user U in the virtual space VR1. In the example of FIG. 6, the line-of-sight information “OBJ1 IS VIEWED” included in records R12 and R22 indicates that the object OBJ1 was disposed on the line of sight of the user U1 or U2 in the virtual space VR1.

### (Emotion Information)

The emotion information includes information indicating a magnitude of a predetermined emotion. In the example of FIG. 6, the predetermined emotion is an emotion that indicates “concentration”. In this case, for example, the magnitude of the predetermined emotion is expressed in terms of the “concentration level”. Further, the predetermined emotion may be information indicating “stress”. In this case, for example, the magnitude of the predetermined emotion is expressed in terms of a “stress level”. However, the predetermined emotion is not limited to the above examples.

### (Configuration of the HMD 20)

The HMD 20 is a virtual reality device that is worn by a user U for experiencing a virtual reality. The following description will discuss a configuration of the HMD 20 with reference to FIG. 4. As illustrated in FIG. 4, the HMD 20 includes a control unit 210, a storage unit 220, a communication unit 230, a display unit 240, and a sensor 250. The control unit 210 carries out overall control of units of the HMD 20. The storage unit 220 stores various data that is to be used by the control unit 210. The communication unit 230 transmits and receives data to and from another apparatus under the control of the control unit 210.

The HMD 20 is also configured to be attachable to a head as illustrated in FIG. 3. The display unit 240 is disposed so as to be positioned in front of both eyes of the user U when the HMD 20 is worn on the head of the user U. The display unit 240 may be a non-transmission type or a transmission type. Further, the HMD 20 may be a closed type that covers both eyes of the user U or may be an open type like eyeglasses. The sensor 250 is a sensor that detects the orientation of the HMD 20 in a real space, and is constituted by, for example, an acceleration sensor, a gyro sensor, or the like. Note that the sensor 250 may be disposed outside the HMD 20. In this case, for example, the sensor 250 may be a camera disposed around the user U.

The control unit 210 receives information indicating the virtual space VR1 from the server 10A and displays the information on the display unit 240. The control unit 210 transmits, to the server 10A, the orientation of the HMD 20 (detected by the sensor 250), an orientation of the operation device 30 (detected by the operation device 30, which will be described later), and a pulse wave of the user U (detected by the sensor 40, which will be described later).

### (Operation Device 30)

The operation device 30 is an input apparatus that receives an operation of the user U in the virtual space VR1. For example, the operation device 30 is configured to allow the user U to hold the operation device 30. Further, for example, the operation device 30 includes a sensor (not shown) that detects the orientation of the operation device 30 in the real space. In this case, a position that is pointed by the user U in the virtual space VR1 may be identified on the basis of the orientation of the operation device 30. Further, for example, a virtual pointer object (not shown) may be displayed at a position indicated by the user U in the virtual space VR1 in accordance with the orientation of the operation device 30.

### (Sensor 40)

The sensor 40 measures sensor information for recognition of an emotion of the user U. In this example, the sensor 40 is a wristband type sensor that measures a pulse wave of the user U. However, the sensor 40 may not necessarily be of the wristband type. The sensor 40 may be another type of sensor as long as the sensor 40 measures information that can be referred to in an emotion recognition technology for recognition of an emotion of the user U. A specific example of the sensor information that can be referred to in the emotion recognition technology is as described in the first example embodiment.

### (Terminal 50)

The terminal 50 is a computer for viewing the analysis result G1. Hereinafter, a user who views the analysis result G1 with use of the terminal 50 is described as a viewer. For example, the viewer may be a user U who carried out a task related to the analysis result G1, or may be another user U who is different from the user U. Further, the viewer may be a manager who manages a plurality of users U. In other words, the user U can view, on the terminal 50, the analysis result G1 that is related to the task carried out by the user U. Further, the user U can view, on the terminal 50, the analysis result G1 that is related to a task carried out by another user U who is different from the user U. Further, the manager can view, on the terminal 50, the analysis result G1 that is related to a task(s) carried out by a plurality of users U.

The following will discuss a configuration of the terminal 50, with reference to FIG. 4. As illustrated in FIG. 4, the terminal 50 includes a control unit 510, a storage unit 520, a communication unit 530, a display unit 540, and an input unit 550. The control unit 510 carries out overall control of units of the terminal 50. The storage unit 520 stores various data that is to be used by the control unit 510. The communication unit 530 transmits and receives data to and from another apparatus under the control of the control unit 510. The display unit 540 is constituted by, for example, a display, and displays information under the control of the control unit 510. The input unit 550 is constituted by, for example, a touch pad or the like and receives an input from a viewer.

Note that the display unit 540 and the input unit 550 may be integrally formed so as to be, for example, a touch panel or the like. Further, the display unit 540 and/or the input unit 550 may not be included inside the terminal 50, and may be connected, as peripheral equipment, outside the terminal 50.

### <Flow of Information Processing Method S1A>

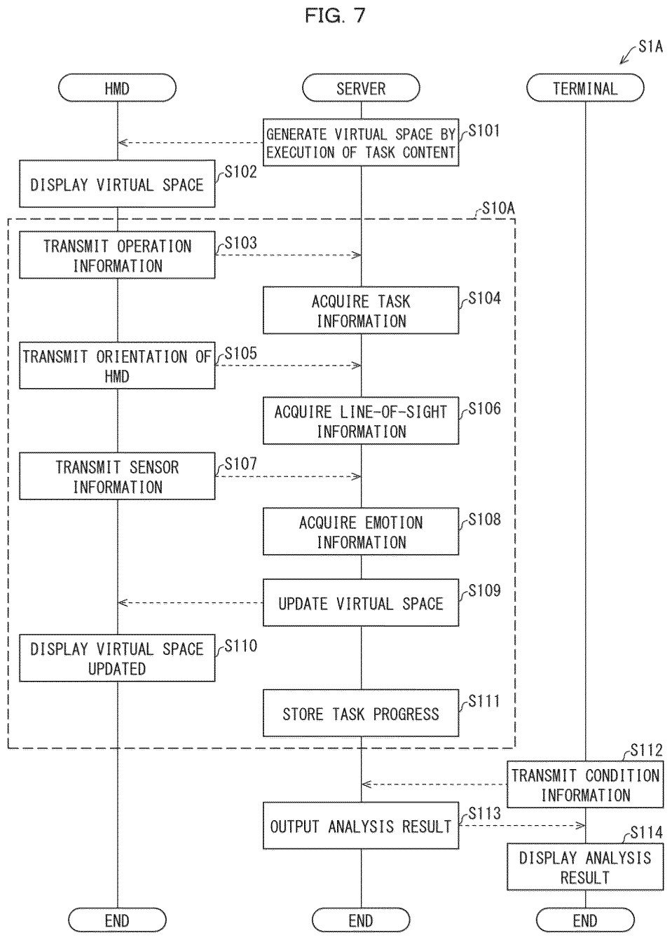

The information processing system 1A configured as described above carries out an information processing method S1A according to the present example embodiment. The following description will discuss a flow of the information processing method S1A with reference to FIG. 7. FIG. 7 is a flowchart showing a flow of the information processing method S1A. As illustrated in FIG. 7, the information processing method S1A includes steps S101 to S114.

### (Step S101)

In step S101, the content execution unit 15A of the server 10A executes the task content AP1 and generates a virtual space VR1 that allows the user U to carry out a task therein. The content execution unit 15A also transmits, to the HMD 20, information indicating the virtual space VR1 thus generated.

For example, the step S101 may be carried out in response to an operation that is carried out by the user U for giving an instruction to start the task content AP1. Such an operation may be carried out, for example, with respect to the operation device 30.

### (Step S102)

In step S102, the control unit 210 of the HMD 20 displays, on the display unit 240, information indicating the virtual space VR1. As a result, a work environment that allows the user U wearing the HMD 20 to carry out a task A, a task B, and a task C in the virtual space VR1 is provided.

### (Step S103)

In step S103, the control unit 210 acquires operation information in accordance with an operation of the user U with respect to the operation device 30. For example, the operation information is information that includes the orientation of the operation device 30. Further, the control unit 210 transmits the operation information to the server 10A.

### (Step S104)

In step S104, the task information acquisition unit 11A of the server 10A acquires task information on the basis of the operation information received.

For example, the task information acquisition unit 11A identifies an object OBJ that was operated by the user U, on the basis of the operation information. Further, the task information acquisition unit 11A identifies the type of a task corresponding to the object OBJ identified, by referring to the content data DT1. Here, it is assumed that a task of the type was not identified in an immediately preceding period. In this case, the task information acquisition unit 11A may determine that a task of the type was started, and may acquire task information indicating a “task of the type is started”.

Further, for example, the task information acquisition unit 11A is assumed to have determined that there is no object OBJ that was operated by the user U on the basis of the operation information. Further, it is assumed that one type of a task has been identified in an immediately preceding period. In this case, the task information acquisition unit 11A may determine that the task of the type was ended, and may acquire task information indicating “the task of the type is ended”.

Note that the task information acquisition unit 11A may not acquire the task information in a case where (a) there is no object OBJ that was operated by the user U and (b) the type of a task in an immediately preceding period has not been identified.

### (Step S105)

In step S105, the control unit 210 of the HMD 20 transmits, to the server 10A, information indicating the orientation of the HMD 20 which has been detected by the sensor 250.

### (Step S106)

In step S106, the line-of-sight information acquisition unit 12A of the server 10A acquires line-of-sight information on the basis of the orientation of the HMD 20 which has been received. For example, the line-of-sight information acquisition unit 12A calculates a line of sight of the user U in the virtual space VR1 on the basis of the information indicating the orientation of the HMD 20 which has been received. Further, the line-of-sight information acquisition unit 12A identifies an object OBJ which is disposed on the line of sight. In this case, the task information acquisition unit 11A may acquire line-of-sight information indicating “identified object OBJ is viewed”.

### (Step S107)

In Step S107, the control unit 210 of the HMD 20 transmits, to the server 10A, the sensor information that has been acquired by the sensor 40. Specifically, information indicating a pulse wave of the user U is transmitted to the server 10A.

### (Step S108)

In step S108, the emotion information acquisition unit 13A of the server 10A acquires, on the basis of the sensor information that has been received, the magnitude of a predetermined emotion included in emotion information. As for a method of acquiring the magnitude of the predetermined emotion on the basis of the sensor information, a known emotion recognition technology can be employed.

### (Step S109)

In step S109, the content execution unit 15A updates the virtual space VR1 according to the operation information that has been received in step S103. The content execution unit 15A transmits, to the HMD 20, information indicating the virtual space VR1 that has been updated.

For example, the content execution unit 15A updates the position of a pointer object in the virtual space VR1, on the basis of the operation information. Further, for example, the content execution unit 15A may update, according to the task content AP1, a display aspect or position of the object OBJ, a display aspect of the virtual space VR1, or the like on the basis of the operation information.

### (Step S110)

In step S110, the control unit 210 of the HMD 20 displays, on the display unit 240, information indicating the virtual space VR1 updated. As a result, in response to the operation with respect to the operation device 30 by the user U, the virtual space VR1 in which the user U virtually exists is updated.

### (Step S111)

In step S111, the control unit 110A of the server 10A associates and stores, in the task progress database DB1, the task information, the line-of-sight information, and the emotion information that were acquired in steps S104, S106, and S108 with an elapsed time that was acquired.

Note that some or all of steps S103 to S111 may be executed in a different order or in parallel. Further, processing including steps S103 to S111 is referred to as step S10A. Step S10A is repeated while the user U is executing the task content AP1. A specific example of information that is stored in the task progress database DB1 by repeating step S10A will be described below with reference to FIG. 6. As illustrated in FIG. 6, the task progress database DB1 includes a record group R1 that is related to the user U1 and a record group R2 that is related to the user U2.

### (Specific Example of Information Stored in Task Progress Database DB1)

The record group R1 indicates information that is related to a task which the user U1 carried out by starting the task content AP1 at 12:30 on Feb. 28, 2022. The record group R1 includes records R11, R12, R13, and R14. The record R11 indicates that at an elapsed time of “0 minutes” from the start of the task content AP1, the following information is acquired: the emotion information (in this example, the concentration level) is “70%”. The record R12 indicates that at an elapsed time of “5 minutes”, information including the line-of-sight information “OBJECT OBJ1 IS VIEWED” and a concentration level of “60%” is acquired. The record R13 indicates that at an elapsed time of “10 minutes”, information including the task information “TASK A IS STARTED” and a concentration level of “50%” is acquired. The record R14 indicates that at an elapsed time of “15 minutes”, information including the task information “TASK A IS ENDED” and a concentration level of “60%” is acquired.

The record group R2 indicates information that is related to a task which the user U2 carried out by starting the task content AP1 at 13:15 on Feb. 1, 2022. The record group R2 includes records R21, R22, and R23. The record R21 indicates that at an elapsed time of “0 minutes” from the start of the task content AP1, the following information is acquired: the concentration level is “65%”. The record R22 indicates that at an elapsed time of “3 minutes”, information including the line-of-sight information “OBJECT OBJ1 IS VIEWED” and a concentration level of “63%” is acquired. The record R23 indicates that at an elapsed time of “7 minutes”, information including the task information “TASK A IS STARTED” and a concentration level of “67%” is acquired.

### (Step S112)

In step S112, the control unit 510 of the terminal 50 acquires condition information that is inputted to the input unit 550 by the viewer. The condition information indicates a condition that is related to at least one selected from the group consisting of the task information, the line-of-sight information, the emotion information, and the information that is related to the user U. Further, the condition information indicates a condition for extracting information that should be outputted as the analysis result G1. The control unit 510 transmits, to the server 10A, the condition information thus acquired.

### (Specific Example of Condition Information)

The following description will discuss a specific example of the condition information. For example, the condition information may be information indicating a condition related to the task information. Examples of such condition information include information that specifies the start, end, or type of the task. Further, for example, the condition information may be information indicating a condition related to the line-of-sight information. Examples of such condition information include information that specifies a viewed object OBJ. Further, for example, the condition information may be information indicating a condition related to the emotion information. Such condition information can be, for example, whether a magnitude of a predetermined emotion (e.g., a concentration level, a stress level, etc.) is equal to or higher or lower than a threshold value, or the like. As another example of the condition information, there is information that specifies, for example, a predetermined number of persons in order from the highest or lowest, or the like among a plurality of users U in terms of the magnitude of a predetermined emotion (e.g., a concentration level, a stress level, or the like). Further, for example, the condition information may be information indicating a condition related to the user U. Examples of such condition information include information that specifies a user U who is a model person or a user U who is a non-model person. In this case, which user U is a model person may be set separately. Examples of such condition information also include information that specifies an attribute of the user U. In this case, the attribute of the user U may be acquirable. However, the condition information is not limited to the above-described examples.

### (Step S113)

In step S113, the relevance information output unit 14A analyzes relevance between a change in the task information, a change in the line-of-sight information, and a change in the emotion information, which are associated with a progress of the task carried out by the user U. Then, the relevance information output unit 14A generates an analysis result G1. Further, the relevance information output unit 14A transmits the analysis result G1 to the terminal 50.

Specifically, for example, the relevance information output unit 14A may output, as the analysis result G1, information that satisfies a condition which is indicated by the condition information received. Further, for example, the relevance information output unit 14A may output respective analysis results related to the plurality of users U in a comparable manner.

Further, for example, the relevance information output unit 14A may output, as the analysis result G1, information that includes: a graph that indicates a change in the emotion information with respect to an elapsed time of the task; and the task information or the line-of-sight information that was acquired at any elapsed time point shown in the graph.

Further, for example, the relevance information output unit 14A may output, as the analysis result G1, information that includes task information or line-of-sight information that was acquired at an elapsed time point at which the change in the emotion information associated with the progress of the task is larger than changes in the emotion information before and after the change in the emotion information.

Furthermore, for example, the relevance information output unit 14A may output, as the analysis result G1, information which includes information that indicates a cause due to which the change in the emotion information associated with the progress of the work is larger than changes in the emotion information before and after the change in the emotion information. For example, as the information indicating a cause, the line-of-sight information or the task information may be specified. Note that as for a technology for identifying the cause due to which the change in the emotion information is larger than changes in the emotion information before and after the change in the emotion information, a well-known technology can be employed.

### (Step S114)

In step S114, the control unit 510 of the terminal 50 displays, on the display unit 540, the analysis result G1 which has been received. Hereinafter, displaying on the display unit 540 may also be described simply as displaying on the terminal 50.

### (First Specific Example of Analysis Result G1)

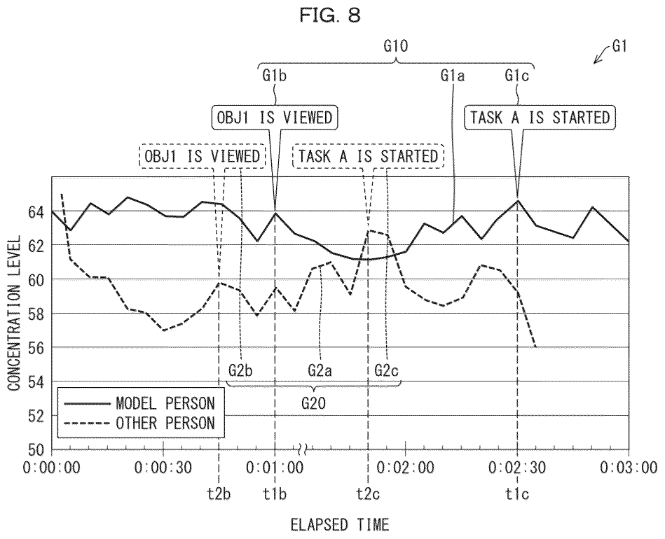

The following will discuss a first specific example of the analysis result G1 displayed on the terminal 50, with reference to FIG. 8. FIG. 8 is a diagram illustrating the first specific example of the analysis result G1 that is displayed on the terminal 50.

In FIG. 8, the first specific example of the analysis result G1 includes an analysis result G10 that is related to a model person and an analysis result G20 that is related to a non-model person (other person). For example, the model person may be a user U who is set as a model person by a manager. The first specific example of such analysis results G1 may be displayed by acquiring, in step S112, information that specifies the “model person” and the “non-model person (other person)” as the condition information that is related to the user U.

Further, the analysis result G10 includes a graph G1a, a speech bubble G1b that indicates line-of-sight information, and a speech bubble G1c that indicates task information. Further, the analysis result G20 includes a graph G2a, a speech bubble G2b that indicates line-of-sight information, and a speech bubble G2c that indicates task information. The graphs G1a and G2a share a vertical axis and a horizontal axis. In the graphs G1a and G2a, the horizontal axis represents an elapsed time after the task content AP1 is started, and the vertical axis represents the concentration level (the magnitude of a predetermined emotion that is an example of the emotion information). Here, sharing of the horizontal axis (elapsed time) by the graphs G1a and G1b does not necessarily indicate that the model person and the non-model person started the task content AP1 at the same time. The task content AP1 may be started by the model person and the non-model person at the same time or respective different times. In this specific example, the analysis result G10 that is related to the model person and the analysis result G20 that is related to the non-model person can be compared with each other by display of the graphs G1a and G1b that share the horizontal axis and the vertical axis.

The speech bubble G1b indicates that the object OBJ1 was viewed at an elapsed time point t1b from when the model person started the task content AP1. Further, the speech bubble G1c indicates that the task A was started at an elapsed time point t1c from when the model person started the task content AP1.

For example, the speech bubbles G1b and G1c may be displayed in step S113 by identification of the time points t1b and t1c as the elapsed time points at each of which the change in the concentration level of the model person is higher than concentration levels of the model person before and after the change in the concentration level. Further, the speech bubbles G1b and G1c may be displayed as “information that indicates a cause due to which the change in the concentration level is higher than changes in the concentration level before and after the change in the concentration level”.

The speech bubbles G2b and G2c are similarly described by reading G1 as G2 in the above-described description of the speech bubbles G1b and G1c and also reading the model person as the non-model person.

This allows a viewer to compare and ascertain respective progresses of tasks carried out by the model person and the non-model person (other person). For example, the viewer can ascertain the following: “the model person views the object OBJ1 later than the non-model person”; “the model person starts the task A later than the non-model person”; “respective concentration levels of both of the model person and the non-model person largely change at the time point at which the object OBJ1 is viewed and at the time point at which the task A is started”; and the like.

### (Second Specific Example of Analysis Result G1)

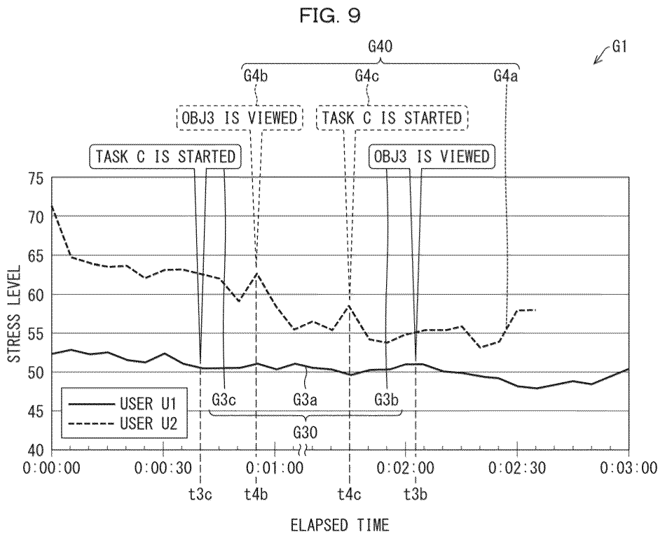

The following will discuss a second specific example of the analysis result G1 displayed on the terminal 50, with reference to FIG. 9. FIG. 9 is a diagram illustrating the second specific example of the analysis result G1 that is displayed on the terminal 50.

In FIG. 9, the second specific example of the analysis result G1 includes an analysis result G30 that is related to the user U1 and an analysis result G40 that is related to the user U2. The second specific example of the analysis result G1 may be displayed by acquiring, in step S112, information that specifies the “user U1” and the “user U2” as the condition information that is related to the user U.

The analysis results G30 and G40 are described in substantially the same manner by replacing “G10, G20, model person, non-model person, OBJ1, task A, and concentration level” in the description of the first specific example of the analysis result G1 by “G30, G40, user U1, user U2, OBJ3, task C, and stress level”.

However, the second specific example of the analysis result G1 differs from the first specific example in the following points. In the first specific example, the speech bubbles G1b, G1c, G2b, and G2c were described as being displayed for elapsed time points at which the change in the concentration level is higher than changes in the concentration level before and after the change in the concentration level. In the second specific example, the speech bubbles G3b and G4b are displayed as a result of acquiring, in the step S112, information that specifies that “OBJECT OBJ3 IS VIEWED” as the condition information that is related to the line-of-sight information. The speech bubbles G3c and G4c are displayed as a result of acquiring, in step S112, information that specifies “TASK C IS STARTED” as the condition information that is related to the task information.

This allows a viewer to compare and ascertain respective progresses of tasks carried out by the user U1 and the user U2. For example, the viewer can ascertain that “the user U2 starts the task C after viewing the object OBJ3, while the user U1 views the object OBJ3 after starting the task C”.

In the second specific example of the analysis result G1, the analysis results G30 and G40 may be analysis results that are related to respective progresses of tasks that are carried out by one user U at different timings. In this case, the viewer can compare and ascertain the progresses of the tasks that ware carried out by the one user U at the different timings.

### Example Advantage of Present Example Embodiment

As described above, the present example embodiment employs a configuration that outputs, as the analysis result G1 (information indicating relevance), information including: a graph that indicates a change in emotion information with respect to an elapsed time of a task; and task information or line-of-sight information that was acquired at any elapsed time point indicated in the graph.

Therefore, the viewer who views the analysis result G1 can more sufficiently ascertain how the task information changes or how the line-of-sight information changes in response to a change in the emotion information associated with a progress of the task.

Further, the present example embodiment employs a configuration that outputs, as the analysis result G1 (information indicating relevance), information including task information or line-of-sight information that was acquired at an elapsed time point at which a change in emotion information associated with a progress of a task is larger than changes in the emotion information before and after the change in the emotion information. For example, in the above-described graph, a speech bubble that indicates the task information or the line-of-sight information is associated with a point at which the change is larger than those before and after the change, and is displayed.

Therefore, the viewer who views the analysis result G1 can more sufficiently ascertain how the task information changes or how the line-of-sight information changes at an elapsed time point at which the change in the emotion information is larger than changes in the emotion information before and after the change in the emotion information.

Further, the present example embodiment employs a configuration that outputs, as the analysis result G1 (information indicating relevance), information indicating a cause due to which the change in the emotion information associated with the progress of the work is larger than changes in the emotion information before and after the change in the emotion information. For example, in the above-described graph, a speech bubble that indicates the task information or the line-of-sight information is associated with a point at which the change is larger than the changes before and after the change, as the information indicating a cause, and is displayed.

Therefore, the viewer who views the analysis result G1 can more sufficiently ascertain a cause due to which a change in emotion information in a progress of a task is larger than changes in the emotion information before and after the change in the emotion information (for example, whether the cause is the task information or the line-of-sight information).

Further, the present example embodiment employs a configuration that outputs, as the analysis result G1 (information indicating relevance), information that satisfies a condition related to at least one selected from the group consisting of the task information, the line-of-sight information, the emotion information, and the user U. Such a condition can be inputted by, for example, a viewer.

Therefore, the viewer who inputs the condition and views the analysis result G1 can view the analysis result G1 that is related to information of viewer's interest. For example, the viewer can view the analysis result G1 that is related to: task information of interest (for example, a type of a task); line-of-sight information of interest (for example, an object OBJ viewed); a user U of interest (for example, a model person); or the like.

Further, the present example embodiment employs a configuration in which: the task information includes task information that is related to a plurality of users U; the emotion information includes emotion information that is related to the plurality of users U; the line-of-sight information includes line-of-sight information that is related to the plurality of users U; and respective analysis results that are related to the users U are outputted in a comparable manner.

Therefore, the viewer who views the analysis result G1 that includes the respective analysis results for the users U in a comparable manner can compare and more sufficiently ascertain respective progresses of tasks that were carried out by the users U. For example, the viewer can compare and ascertain respective progress of tasks that were carried out by a plurality of users U. Alternatively, the viewer can compare and ascertain respective progresses of tasks that were carried out by one user U at different timings.

Further, the present example embodiment employs a configuration in which the emotion information includes information indicating a magnitude of a predetermined emotion.

Therefore, the viewer who views the analysis result G1 can ascertain relevance between a change in the magnitude of the predetermined emotion (e.g., the concentration level, the stress level, or the like) of a user U and a change in the task information or a change in the line-of-sight information, which are associated with a progress of a task.

Further, the present example embodiment employs a configuration in which the line-of-sight information includes information indicating a virtual object disposed on a line of sight in the virtual space VR1.

Therefore, the viewer who views the analysis result G1 can ascertain relevance between a change in a virtual object viewed by the user U and a change in the task information or a change in the emotion information, which are associated with a progress of a task.

Further, the present example embodiment employs a configuration in which the task information includes information indicating the start, end, or type of a task.

Therefore, the viewer who views the analysis result G1 can ascertain relevance between a change in the start, end, type or the like of the task and a change in the line-of-sight information or a change in the emotion information.

### Third Example Embodiment

The following description will discuss in detail a third example embodiment of the present invention, with reference to the drawings. Note that components having the same functions as those described in the first or second example embodiment are denoted by the same reference numerals, and descriptions thereof will be omitted accordingly.

### (Configuration of Information Processing System 1B)

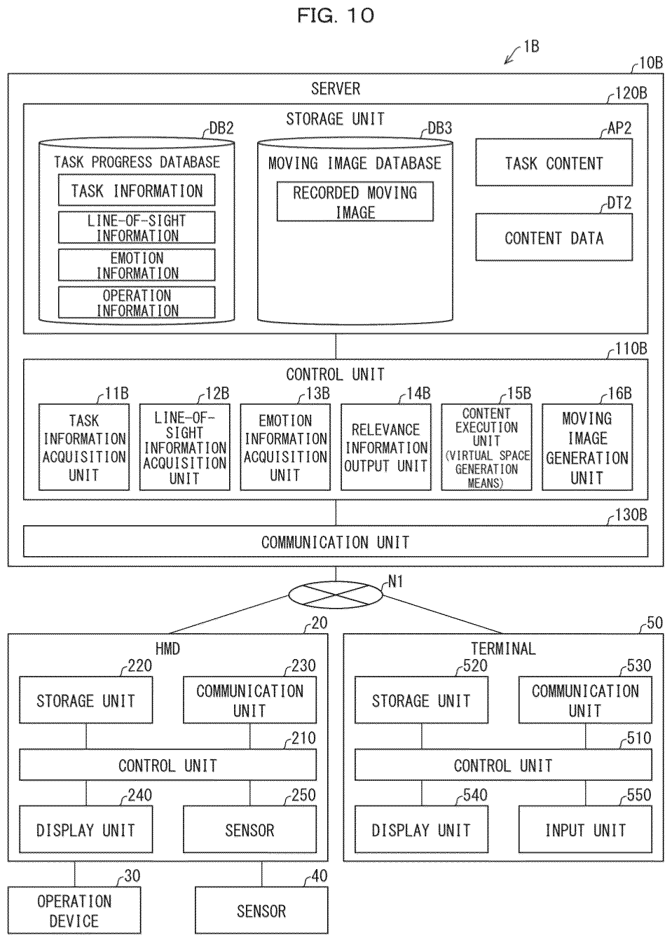

The following will describe a configuration of an information processing system 1B according to the present example embodiment, with reference to FIG. 10. FIG. 10 is a block diagram illustrating a configuration of the information processing system 1B. As illustrated in FIG. 10, the information processing system 1B is configured in substantially the same manner as the information processing system 1A, but is different in that the information processing system 1B includes a server 10B in place of the server 10A. Detailed description of configurations that are similar to those of the first example embodiment will not be repeated.

### (Configuration of Server 10B)

The server 10B is a computer that analyzes a progress of a task of a user U in a virtual space VR2. The configuration of the server 10B will be described with reference to FIG. 10. As illustrated in FIG. 10, the server 10B includes a control unit 110B, a storage unit 120B, and a communication unit 130B. The control unit 110B carries out overall control of units of the server 10B. The storage unit 120B stores various data that is to be used by the control unit 110B. The communication unit 130B transmits and receives data to and from another apparatus under the control of the control unit 110B.

The control unit 110B includes a task information acquisition unit 11B, a line-of-sight information acquisition unit 12B, an emotion information acquisition unit 13B, a relevance information output unit 14B, a content execution unit 15B, and a moving image generation unit 16B. The task information acquisition unit 11B, the line-of-sight information acquisition unit 12B, and the emotion information acquisition unit 13B are configured in the same manner as respective functional blocks having the same names in the second example embodiment. The relevance information output unit 14B is configured in substantially the same manner as the relevance information output unit 14A, but at least differs from the relevance information output unit 14A in that the relevance information output unit 14B outputs an analysis result G2 in place of the analysis result G1. The analysis result G2 includes a moving image which will be described later. The content execution unit 15B is configured in substantially the same manner as the content execution unit 15A, but at least differs from the content execution unit 15A in that task content AP2 is executed in place of the task content AP1. The moving image generation unit 16B generates a moving image in which the virtual space VR2 is captured with use of a virtual camera. Details of each unit included in the control unit 110B will be described below in the section “Flow of information processing method S1B”.

Further, various data stored in the storage unit 120B include a task progress database DB2, a moving image database DB3, content data DT2, and the task content AP2.

### (Task Progress Database DB2)

The task progress database DB2 is configured in substantially the same manner as the task progress database DB1 and, in addition, stores operation information that is acquired at each elapsed time point of a task. The operation information is information indicating an operation object that was operated by a user U. The operation object will be described later. For example, the task progress database DB2 may be configured to store a record that further includes an item of the operation information in each record of the task progress database DB1 whose specific example is illustrated in FIG. 6. However, information and a data structure thereof, which are stored in the task progress database DB2, are not limited to the above-described examples.

### (Moving Image Database DB3)

The moving image database DB3 stores a recorded moving image in which a progress of a task is recorded by a user U. The recorded moving image is generated by capturing an image of a progress of a task in the virtual space VR2 with use of the virtual camera. For example, the moving image database DB3 stores the recorded moving image in association with a user ID and execution date and time. For example, information that is related to a progress of a task recorded in the recorded moving image can be acquired from the task progress database DB1 on the basis of the user ID and the execution date and time which have been associated with the recorded moving image.

For example, the virtual camera may be disposed at a position of the user U in the virtual space VR2. Further, an image capture direction of the virtual camera may be set to the direction of a line of sight of the user U. In this case, the recorded moving image that is captured by the virtual camera is a moving image obtained by recording the work space VR2 which the user U views while carrying out a task. Further, for example, the virtual camera may be disposed at a predetermined position in the virtual space VR2. Furthermore, the image capture direction of the virtual camera may be a direction in which the user U is included in an angle of view. In this case, the recorded moving image that is captured by the virtual camera is obtained by capturing, from a predetermined position, an image of the user U who carries out the task in the work space VR2. Such a recorded moving image is generated by the moving image generation unit 16B controlling the position, the image capture direction, the angle of view, and the like of the virtual camera. However, the recorded moving image and a data structure thereof that are stored in the moving image database DB3 are not limited to the examples described above.

### (Task Content AP2)

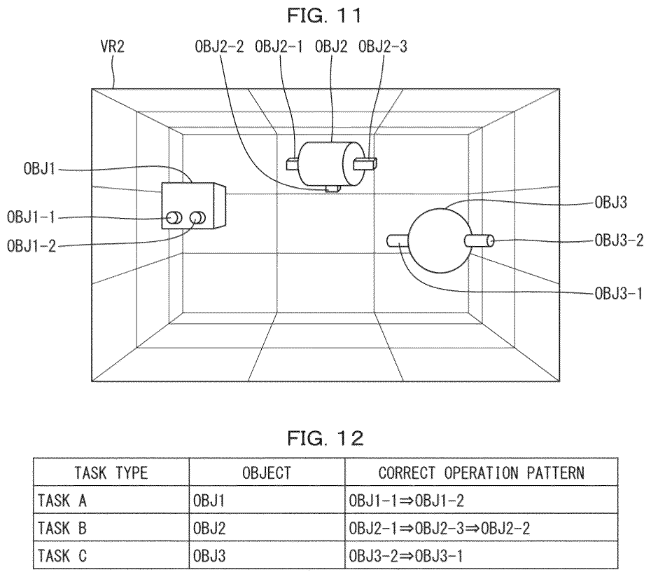

The task content AP1 is an application program for providing a work environment to the user U in the virtual space VR2. The task content AP2 can be described in substantially the same manner as the task content AP1 in the first example embodiment. However, the virtual space VR2 that is generated by execution of the task content AP2 is slightly different from the virtual space VR1. The following description will discuss the virtual space VR2 with reference to FIG. 11. FIG. 11 is a diagram schematically illustrating an example of the virtual space VR2. The virtual space VR2 includes objects OBJ1, OBJ2, and OBJ3. Further, the object OBJ1 includes operation objects OBJ1-1 and OBJ1-2 for operating the object OBJ1. The object OBJ2 includes operation objects OBJ2-1, OBJ2-2, and OBJ2-3 for operating the object OBJ2. The object OBJ3 includes operation objects OBJ3-1 and OBJ3-2 for operating the object OBJ3.

### (Content Data DT2)

The content data DT2 is data that is referred to when the content execution unit 15B executes the task content AP2. The following description will discuss an example of the content data DT2 with reference to FIG. 12. FIG. 12 is a diagram illustrating an example of the content data DT2. As illustrated in FIG. 12, the content data DT2 includes information indicating a type of a task, a target object OBJ, and a correct answer operation pattern. For example, a task A is a task that targets the object OBJ1, and a pattern in which the operation objects OBJ1-1 and OBJ1-2 are operated in this order is a correct answer for the task A. A task B is a task that targets the object OBJ2, and a pattern in which the operation objects OBJ2-1, OBJ2-3, and OBJ2-2 are operated in this order is a correct answer for the task B. A task C is a task that targets the object OBJ3, and a pattern in which the operation objects OBJ3-2 and OBJ3-1 are operated in this order is a correct answer for the task C. The tasks A, B, and C are included in the task content AP2. In a case where an operation targeting an object OBJ is carried out, the content execution unit 15B can determine whether or not the pattern of the operation matches a correct answer with reference to the content data DT2.

### (Flow of Information Processing Method S1B)

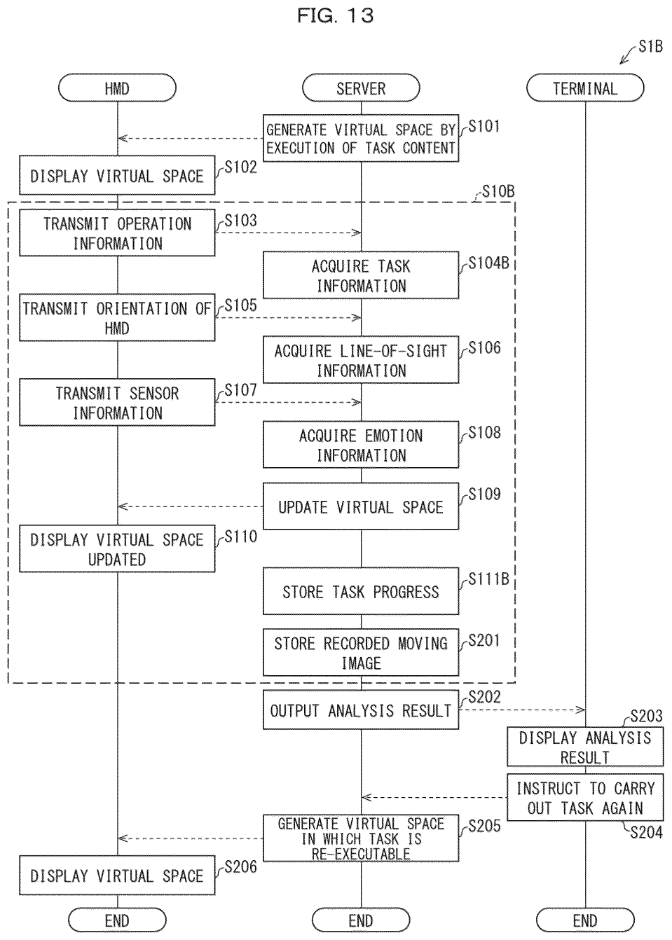

The information processing system 1B configured as described above carries out an information processing method S1B according to the present example embodiment. The following description will discuss a flow of the information processing method S1B with reference to FIG. 13. FIG. 13 is a flowchart showing a flow of the information processing method S1B. As illustrated in FIG. 13, the information processing method S1B includes steps S101 to S111B and S201 to S206.

### (Steps S101 to S111B)

Steps S101 to S111B can be described in substantially the same manner as steps S101 to S111 of the second example embodiment by replacing “A” at the end of each reference sign, and reference signs “VR1” and “AP1” in the description of steps S101 to S111 of the second example embodiment by “B, VR2, and AP2”, respectively. However, the present example embodiment differs from the second example embodiment in that instead of steps S104 and S111, steps S104B and S111B are executed.

### (Step S104B)

In step S104B, the task information acquisition unit 11B of the server 10B acquires task information on the basis of the operation information received. The task information includes information indicating a degree of appropriateness of an operation associated with a task, or start, end, or type of a task. A specific example of a process for acquiring task information that includes the start, end, or type of the task is as described in step S104. Here, a specific example of a process for acquiring task information that includes the degree of appropriateness of an operation will be described. The task information acquisition unit 11B calculates the degree of appropriateness of an operation associated with a task, by collating, with the correct answer operation pattern included in the content data DT2, the operation information received.

For example, it is assumed that in the task progress database DB2, pieces of operation information “OBJ1-2” and “OBJ1-1” are stored in order in association with respective elapsed time points from start to end of the task A. In this case, the operation pattern of the user U is “OBJ1-2=>OBJ1-1”. The operation pattern of the user U does not match the correct answer operation pattern “OBJ1-1=>OBJ1-2” of the task A included in the content data DT2. In this case, the task information acquisition unit 11B acquires task information including information (for example, “operation error”) that indicates that the operation is not appropriate, and stores this task information in the task progress database DB2.

### (Step S111B)

In step S1111B, the control unit 110B of the server 10B stores, in the task progress database DB2, the operation information, the task information, the line-of-sight information, and the emotion information, which have been acquired in S104B, S106, and S108.

### (Step S201)

In step S201, the moving image generation unit 16B controls the virtual camera and generates a recorded moving image in which an image of a progress of a task in the virtual space VR2 is captured.

Note that some or all of steps S103 to S111B and S201 may be executed in a different order or in parallel.

Further, processing including steps S103 to S111B and S201 is referred to as step S10B. Step S10B is repeatedly carried out while the user U executes the task content AP2. Through repetition of step S10B, a record in which the operation information is added to the information described as an example with reference to FIG. 6 is stored in the task progress database DB2. Further, through the repetition of step S10B, a recorded moving image of the task carried out by the user U is stored in the moving image database DB3.

### (Step S202)

In step S202, the relevance information output unit 14B analyzes relevance between a change in the task information, a change in the line-of-sight information, and a change in the emotion information, which are associated with the progress of the task carried out by the user U. Then, the relevance information output unit 14B generates the analysis result G2. Further, the relevance information output unit 14B transmits the analysis result G2 to the terminal 50.

Specifically, for example, the relevance information output unit 14B outputs, as the analysis result G2, information that includes: (i) a recorded moving image that is stored in the moving image database DB3 (a moving image in which an image of the progress of the task is captured by the virtual camera disposed in the virtual space VR2); and (ii) the task information, the emotion information, or the line-of-sight information that was acquired at an elapsed time point of the task which corresponds to any reproduction time point of the recorded moving image. Further, the task information included in the analysis result G2 may include the degree of appropriateness of the operation that is associated with the task. A specific example of the degree of appropriateness of the operation is as described above.

### (Step S203)

In step S203, the control unit 510 of the terminal 50 displays, on the display unit 540, the analysis result G2 which has been received.

### (Specific Example of Analysis Result G2)

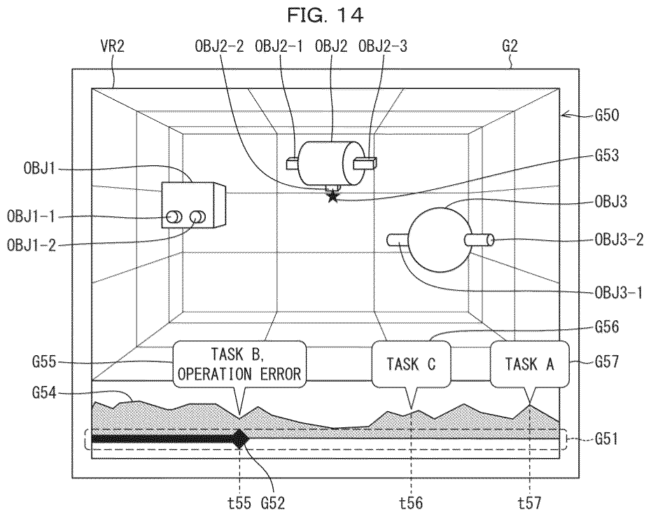

The following will discuss a specific example of the analysis result G2 displayed on the terminal 50, with reference to FIG. 14. FIG. 14 is a diagram illustrating the specific example of the analysis result G2 that is displayed on the terminal 50.

In FIG. 14, the specific example of the analysis result G2 includes a reproduction area G50 of the recorded moving image, a seek bar G51, a marker G52 that indicates a reproduction position, a marker G53 that indicates line-of-sight information, a graph G54 that indicates a change in emotion information, and speech bubbles G55, G56, and G57 that indicates task information.

The seek bar G51 is a figure that has a width corresponding to length of an entire reproduction time of the recorded moving image that is reproduced in the reproduction area G50. The seek bar G51 includes a marker G52 that indicates a current reproduction time point. Further, the reproduction time point of the recorded moving image corresponds to an elapsed time point of the task recorded in the recorded moving image. In the example of FIG. 14, the marker G52 indicates that the current reproduction time point corresponds to the elapsed time point t55. The marker G52 moves as the recorded moving image is reproduced. Further, the marker G52 receives an operation for changing the reproduction time point.

The marker G53 indicates the line-of-sight information that was acquired at the elapsed time point t55 in the past which corresponds to the current reproduction time point. In this example, the marker G53 is superimposed on the reproduction area G50 and displayed. A display position of the marker G53 corresponds to a position toward which the line of sight of the user U is directed in the virtual space VR2 that is shown by the recorded moving image which is being reproduced in the reproduction area G50. In this example, the marker G53 is superimposed in the vicinity of the operation object OBJ2-2. That is, the marker G53 indicates that the user U viewed the operation object OBJ2-2 at the elapsed time point t55. The display position of the marker G53 may move with a change in the line-of-sight information.

The graph G54 is a graph that indicates a change in the concentration level, which is drawn by regarding the seek bar G51 as a horizontal axis (an axis that represents an elapsed time of the task). The speech bubble G55 indicates the task information “TASK A, OPERATION ERROR” that is acquired at the elapsed time point t55 in the past which corresponds to the current reproduction time point. The operation error indicates that the operation pattern that was carried out by the user U for the task A did not match the correct answer operation pattern that is associated with the task A. The speech bubbles G56 and G57 indicate pieces of task information that were acquired at elapsed time points t56 and t57 in the past, respectively.

For example, by viewing the analysis result G2, a viewer can check, in more detail, the progress of the task by reproducing the recorded moving image. Further, in the case where the user U who carried out the task that was recorded in the recorded moving image is the viewer, the user U can look back on the progress of the task by the recorded moving image the progress of the task that was carried out by the user U.

Further, for example, the viewer can recognize, by viewing the analysis result G2, a change in the concentration level which is associated with a progress of a task, while reproducing the recorded moving image. Further, the viewer can recognize that at the elapsed time point t55 corresponding to the current reproduction time point, an operation error of the task B was made.

### (Step S204)

In step S204, the control unit 510 of the terminal 50 acquires re-execution information which indicates that the task is to be carried out again and which is inputted in response to output of the analysis result G2 (information indicating relevance). The control unit 510 transmits, to the server 10B, the re-execution information thus acquired. For example, in the example of FIG. 14, the control unit 510 receives an operation with respect to any of the speech bubbles G55, G56, and G57 each of which indicates task information, as an operation that instructs to carry out again the task that is indicated in the speech bubble. For example, the viewer carries out an operation with respect to the speech bubble G55 in order to carry out again the task A in which an operation error is involved, among the plurality of works A, B, and C. As a result, re-execution information indicating that the task A is to be carried out again is transmitted to the server 10B.

### (Step S205)

In Step S205, in a case where the re-execution information is received, the content execution unit 15B of the server 10B generates a virtual space VR2 that allows the task indicated by the re-execution information to be carried out therein again. Further, the content execution unit 15B transmits, to an HMD 20, information indicating the virtual space VR2 thus generated. For example, in a case where the re-execution information indicating the task A is received, the virtual space VR2 that allows the task A to be carried out therein is generated in step S205. For example, the “virtual space VR2 that allows the task A to be carried out therein” may be a virtual space VR2 in which only the task A can be carried out but no other tasks can be carried out. Further, for example, in a case where it is necessary to complete another task(s) in advance in order to carry out the task A, the “virtual space VR2 that allows the task A to be carried out therein” may be a virtual space VR2 in a state in which the other task(s) has been completed.

### (Step S206)

In step S206, the control unit 210 of the HMD 20 displays, on the display unit 240, information indicating the virtual space VR2. As a result, a work environment that allows the user U wearing the HMD 20 to carry out again a designated task in the virtual space VR2 is provided.

### Example Advantage of Present Example Embodiment

As described above, the present example embodiment employs a configuration that outputs, as the analysis result G2 (information indicating relevance), information including: (i) a recorded moving image (moving image) in which an image of a progress of a task is captured by a virtual camera disposed in the virtual space VR2; and (ii) task information, emotion information, or line-of-sight information that was acquired at an elapsed time point of the task corresponding to any reproduction position of the recorded moving image.

This allows a viewer who views the analysis result G2 to look back on a task having been carried out by user U by reproducing the recorded moving image while recognizing relevance between a change in the task information, a change in the emotion information, and a change in the line-of-sight information.

Further, the present example embodiment employs a configuration that generates a virtual space VR2 that allows the task to be carried out therein again in a case where information that gives an instruction to carry out the task again is inputted in response to output of the analysis result G2. Further, the present example embodiment employs a configuration in which in a case where the analysis result G2 includes a plurality of tasks, the information that is inputted may include information that specifies the task to be carried out again.

For this reason, in a case where the viewer who views the analysis result G2 wishes to carry out a task again on the basis of the analysis result G2, the viewer can call up the virtual space VR2 that allows the task to be carried out therein again.

Further, the present example embodiment employs a configuration in which the task information includes information indicating the degree of appropriateness of an operation associated with the task.

Therefore, the viewer who views the analysis result G2 can ascertain the relevance between (i) a change in the degree of appropriateness of an operation and (ii) a change in the line-of-sight information or a change in the emotion information.

### [First Variation]

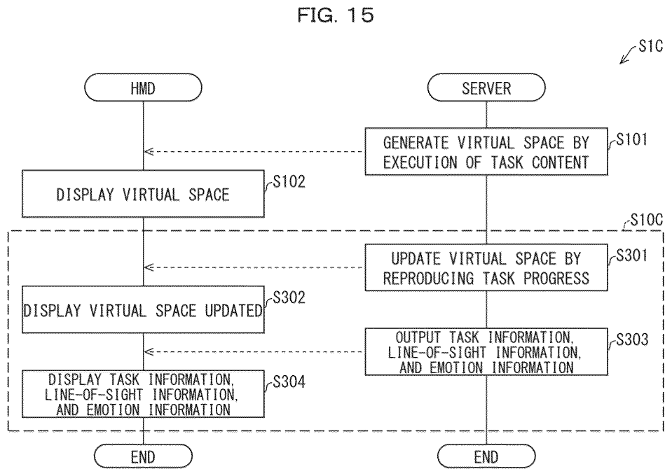

The present example embodiment can be varied to output information indicating relevance in the virtual space VR2 in which a progress of a task carried out in the past is being replicated, instead of outputting the analysis result G2 to the terminal 50. In other words, the information indicating the relevance is displayed on the HMD 20. In the present variation, the information processing system 1B executes an information processing method S1C. The following description will discuss the information processing method S1B according to the present variation, with reference to FIG. 15. FIG. 15 is a flowchart showing a flow of the information processing method S1C of a first variation. In FIG. 15, the information processing method S1C includes steps S101 and S102 and S301 to S304. Steps S101 and S102 are as described earlier with reference to FIG. 13.

### (Step S301)

In step S301, the content execution unit 15B updates the virtual space VR2, on the assumption that an operation indicated by the operation information stored in the task progress database DB2 has been carried out. Thus, the content execution unit 15B replicates, in the virtual space VR2, a progress of a task that was carried out in the past. The content execution unit 15B transmits, to the HMD 20, information indicating the virtual space VR2 that has been updated.

### (Step S302)

In step S302, the control unit 210 of the HMD 20 displays, on the display unit 240, information indicating the virtual space VR2 updated. This causes a user U wearing the HMD 20 to experience a virtual reality, in which the user U looks back, in the virtual space VR2, on the progress of the task that was carried out in the past.

### (Step S303)

In Step S303, the relevance information output unit 14B of the server 10B outputs, to the virtual space VR2 in which the progress of the task is being replicated, the information indicating the relevance. The information indicating the relevance indicates relevance between a change in the task information, a change in the emotion information, and a change in the line-of-sight information, which were acquired when the task being replicated was carried out in the past. Specifically, at a replication time point corresponding to an elapsed time point of the task in the past, the relevance information output unit 14B outputs the task information, the line-of-sight information, and the emotion information, which were acquired at the elapsed time point. Further, the content execution unit 15B updates the virtual space VR2 in accordance with output of the task information, the line-of-sight information, and the emotion information, and transmits, to the HMD 20, the information indicating the virtual space VR2 updated.

For example, the relevance information output unit 14B may place, in the virtual space VR2, a virtual sign object for displaying the type of the task. In this case, the relevance information output unit 14B may display characters “task A” in the sign object at a replication time point corresponding to an elapsed time point of the task in the past for which the task information that “task A was started” was obtained. Further, for example, the relevance information output unit 14B may place, in the virtual space VR2, a virtual line-of-sight object that indicates a position toward which the line of sight of the user U is directed. In this case, the relevance information output unit 14B may change the position of the line-of-sight object on the basis of the line-of-sight information that was acquired at each elapsed time point of the task in the past. Further, for example, the relevance information output unit 14B may place in the virtual space VR2, a virtual indicator object that indicates the magnitude of the emotion information. In this case, the relevance information output unit 14B may change the magnitude indicated by the indicator object on the basis of the emotion information that was acquired at each elapsed time point of the task in the past.

### (Step S304)

In step S304, the control unit 210 of the HMD 20 displays, on the display unit 240, information indicating the virtual space VR2 updated.

Here, processing including steps S301 to S304 is referred to as step S10C. Step S10C is repeatedly carried out while the user U executes the task content AP2. Thus, in the virtual space VR2, a task that was carried out in the past is replicated. Further, the task information, the line-of-sight information, and the emotion information are outputted while varying in accordance with elapse of a replication time. As a result, the user U can ascertain the relevance between a change in the task information, a change in the line-of-sight information, and a change in the emotion information, which are associated with a progress of the task carried out in the past, while looking back on the task in the virtual space VR2.

Note that in the present variation, the user U wearing the HMD 20 may be different from a user U who carried out the task to be replicated. In this case, since the user U wearing the HMD 20 can ascertain the above-described information indicating the relevance while re-experiencing, in the virtual space VR2, a task that was carried out in the past by another user U. Therefore, the user U can use the information as a reference when carrying out the task in the future.

### [Second Variation]

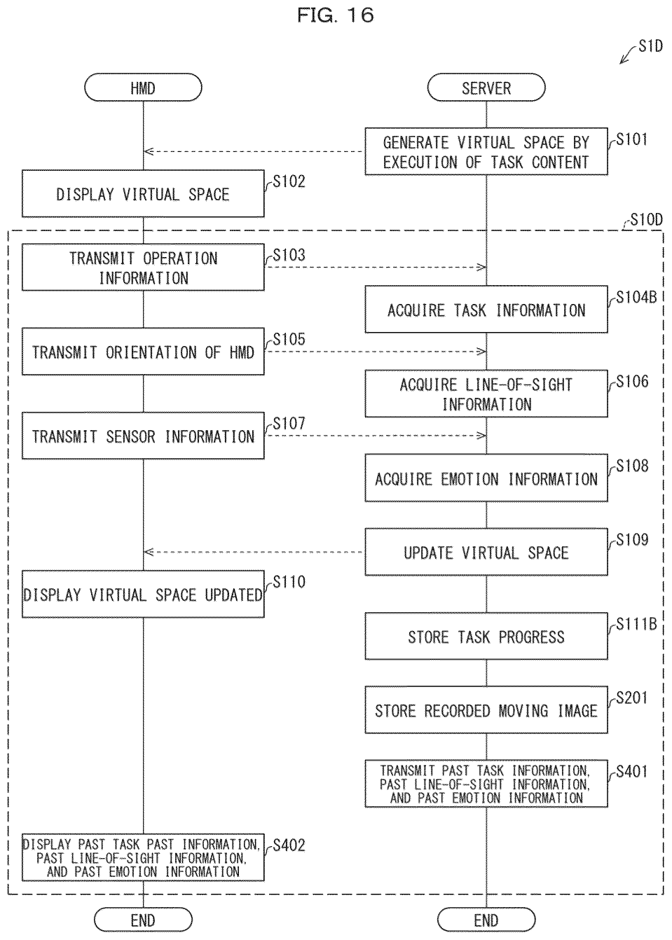

The present example embodiment can be varied to output information indicating relevance in the virtual space VR2 in which a user U is currently carrying out a task, instead of outputting the analysis result G2 to the terminal 50. In other words, the information indicating the relevance is displayed on the HMD 20. In the present variation, the information processing system 1B carries out an information processing method S1D. The following description will discuss the information processing method S1D according to the present variation, with reference to FIG. 16. FIG. 16 is a flowchart showing a flow of the information processing method S1D of a second variation. In FIG. 16, the information processing method S1D includes steps S101 to S111B, S201, S401, and S402. Steps S101 to S111B and S201 are as described above with reference to FIG. 13.

### (Step S401)

In step S401, the relevance information output unit 14B of the server 10B outputs, to the virtual space VR2 in which the user U is currently carrying out a task, information indicating relevance. The information indicating the relevance indicates relevance between a change in the task information, a change in the emotion information, and a change in the line-of-sight information, which were acquired when a task identical to the task currently being carried out was carried out in the past. Specifically, at each elapsed time point of the task currently being carried out, the relevance information output unit 14B outputs the task information, the line-of-sight information, and the emotion information that were acquired at each elapsed time point of the task in the past which corresponds to the elapsed time point of the task currently being carried out. Further, the content execution unit 15B updates the virtual space VR2 in accordance with output of the task information, the line-of-sight information, and the emotion information, and transmits, to the HMD 20, the information indicating the virtual space VR2 updated. The content execution unit 15B may cause “each elapsed time point of the task currently being carried out” and the “elapsed time point of the task in the past” to correspond to each other, on the basis of an elapsed time corresponding to entire task content AP2 or on the basis of an elapsed time corresponding to each task type.

For example, the relevance information output unit 14B may place, in the virtual space VR2, a sign object, a line-of-sight object, and an indicator object that are similar to those in the first variation. In this case, the relevance information output unit 14B may display, on the sign object, characters that indicate the task type, on the basis of the task information that was acquired at an elapsed time point of the task in the past which corresponds to an elapsed time point of the task currently being carried out. Further, for example, the relevance information output unit 14B may change the position of the line-of-sight object on the basis of the line-of-sight information that was acquired at an elapsed time point of the task in the past which corresponds to an elapsed time point of the task currently being carried out. Further, for example, the relevance information output unit 14B may change the magnitude indicated by the line-of-sight object, on the basis of the task information that was acquired at an elapsed time point of the task in the past which corresponds to an elapsed time point of the task currently being carried out.

### (Step S402)

In step S402, the control unit 210 of the HMD 20 displays, on the display unit 240, information indicating the virtual space VR2 updated.

Here, processing including steps S103 to S1111B, S201, S401, and S402 is referred to as step S10D. Step S10D is repeatedly carried out while the user U is executing the task content AP2. This causes the task information, the line-of-sight information, and the emotion information, which were acquired when a task identical to the task currently being carried out by the user U in the virtual space VR2 was carried out in the past, to be outputted while varying in accordance with a progress of the task currently being carried out by the user U. As a result, the user U can carry out the task again while recognizing the relevance between a change in the task information, a change in the line-of-sight information, and a change in the emotion information obtained when the task was carried out in the past.

Note that in the present variation, a user U who carries out a task while wearing the HMD 20 may be different from a user U who carried out the task in the past. In this case, the user U wearing the HMD 20 can carry out the task while referring to the information indicating the relevance related to the task which was carried out by another user U in the past.

### Other Variations

In the above-described example embodiments 2 and 3, another virtual reality device may be used in place of the HMD 20. Further, the HMD 20 may be connected to an audio output apparatus, and audio reproduction may be carried out in the virtual space VR2. Further, the HMD 20 may be connected to an audio input apparatus, and the emotion information acquisition unit 13A, 13B may acquire the emotion information on the basis of the information that has been acquired by the sensor 40 and the audio input apparatus. Furthermore, in each of the above-described example embodiments 2 and 3, part or all of the task progress database DB1, DB2, the moving image database DB3, the task content AP1, AP2, and the content data DT1, DT2 may be stored in the storage unit 220 of the HMD 20, or may be disposed outside the information processing system 1A, 1B. In addition, some or all of functional blocks included in the control unit 110A, 110B of the server 10A, 10B may be disposed in another apparatus included in the information processing system 1A, 1B.

### [Software Implementation Example]

Part or all of functions of respective apparatuses constituting the information processing system 1, 1A, 1B can be realized by hardware such as an integrated circuit (IC chip) or the like or can be alternatively realized by software.

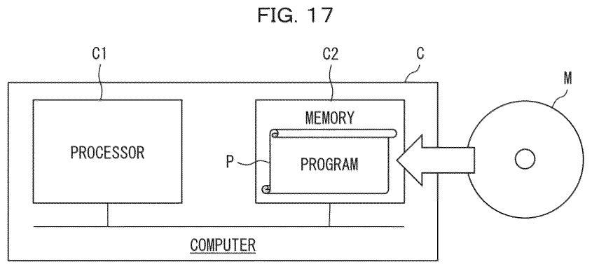

In the latter case, the respective apparatuses constituting the information processing system 1, 1A, 1B are realized by, for example, a computer that executes instructions of a program that is software realizing the foregoing functions. FIG. 17 illustrates an example of such a computer (hereinafter, referred to as “computer C”). The computer C includes at least one processor C1 and at least one memory C2. In the memory C2, a program P for causing the computer C to operate as the respective apparatuses constituting the information processing system 1, 1A, 1B is stored. In the computer C, the foregoing functions of the respective apparatuses constituting the information processing system 1, 1A, 1B can be realized by the processor C1 reading and executing the program P stored in the memory C2.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C may further include a random access memory (RAM) in which the program P is loaded when executed and/or in which various kinds of data are temporarily stored. The computer C may further include a communication interface for transmitting and receiving data to and from another apparatus. The computer C can further include an input-output interface for connecting input-output apparatuses such as a keyboard, a mouse, a display and a printer.

The program P can be stored in a non-transitory tangible storage medium M that can be read by the computer C. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can obtain the program P via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the above example embodiments can be described as below. Note, however, that the present invention is not limited to the following example aspects.

### Supplementary Note 1

An information processing system including:
a task information acquisition means which acquires task information that is related to a task carried out by a user in a virtual space;
a line-of-sight information acquisition means which acquires line-of-sight information that is related to a line of sight of the user;
an emotion information acquisition means which acquires emotion information that is related to an emotion of the user; and
a relevance information output means that outputs information indicating relevance between a change in the task information, a change in the line-of-sight information, and a change in the emotion information, which are associated with a progress of the task.

### Supplementary note 2

The information processing system according to supplementary note 1, wherein the emotion information includes information indicating a magnitude of a predetermined emotion.

### Supplementary note 3

The information processing system according to supplementary note 1 or 2, wherein the line-of-sight information includes information indicating a virtual object disposed on the line of sight in the virtual space.

### Supplementary note 4

The information processing system according to any one of supplementary notes 1 to 3, wherein the task information includes information indicating a degree of appropriateness of an operation associated with the task, or start, end, or type of the task.

### Supplementary note 5

The information processing system according to any one of supplementary notes 1 to 4, wherein
the relevance information output means outputs, as the information indicating the relevance, information including
   a graph that indicates the change in the emotion information with respect to an elapsed time of the task, and
   the task information or the line-of-sight information that was acquired at any elapsed time point indicated in the graph.

### Supplementary note 6

The information processing system according to any one of supplementary notes 1 to 4, wherein
the relevance information output means outputs, as the information indicating the relevance, information including
   a moving image in which an image of the progress of the task is captured by a virtual camera disposed in the virtual space, and
   the task information, the emotion information, or the line-of-sight information that was acquired at any elapsed time point of the task corresponding to any reproduction position of the moving image.

### Supplementary note 7

The information processing system according to any one of supplementary notes 1 to 4, wherein:
the relevance information output means outputs, to the virtual space in which the progress of the task carried out in the past is being replicated, the information indicating the relevance; and
the information indicating the relevance indicates relevance between a change in the task information, a change in the emotion information, and a change in the line-of-sight information, which were acquired when the task being currently replicated was carried out in the past.

### Supplementary note 8

The information processing system according to any one of supplementary notes 1 to 4, wherein:
the relevance information output means outputs, to the virtual space in which the user is carrying out the task, the information indicating the relevance; and
the information indicating the relevance indicates relevance between a change in the task information, a change in the emotion information, and a change in the line-of-sight information, which were acquired when a task identical to the task was carried out in the past.

### Supplementary note 9

The information processing system according to any one of supplementary notes 1 to 8, further including a virtual space generation means that generates the virtual space,
the virtual space generation means generating the virtual space that allows the task to be carried out therein again in a case where information that gives an instruction to carry out the task again is inputted in response to output of the information indicating the relevance.

### Supplementary note 10

The information processing system according to any one of supplementary notes 1 to 9, wherein:
the relevance information output means outputs, as the information indicating the relevance, information that satisfies a condition related to at least one selected from the group consisting of the task information, the line-of-sight information, the emotion information, and the user.

### Supplementary note 11

The information processing system according to any one of supplementary notes 1 to 10, wherein:
the task information includes the task information that is related to a plurality of users;
the emotion information includes the emotion information that is related to the plurality of users;
the line-of-sight information includes the line-of-sight information that is related to the plurality of users; and
the relevance information output means outputs, in a comparable manner, the information that indicates the relevance and that is related to each of the users.

### Supplementary note 12

The information processing system according to any one of supplementary notes 1 to 11, wherein:
the relevance information output means outputs, as the information indicating the relevance, information including the task information or the line-of-sight information which was acquired at an elapsed time point at which the change in the emotion information associated with the progress of the task is larger than changes in the emotion information before and after the change in the emotion information.

### Supplementary note 13

The information processing system according to any one of supplementary notes 1 to 12, wherein:
the relevance information output means outputs, as the information indicating the relevance, information including information indicating a cause due to which the change in the emotion information associated with the progress of the task is larger than changes in the emotion information before and after the change in the emotion information.

### Supplementary note 14

An information processing method, including:
acquiring task information that is related to a task carried out by a user in a virtual space;
acquiring line-of-sight information that is related to a line of sight of the user;
acquiring emotion information that is related to an emotion of the user; and
outputting information indicating relevance between a change in the task information, a change in the line-of-sight information, and a change in the emotion information, which are associated with a progress of the task.

### Supplementary note 15

A program for causing a computer to function as an information processing system, the program causing the computer to function as:
a task information acquisition means which acquires task information that is related to a task carried out by a user in a virtual space;
a line-of-sight information acquisition means which acquires line-of-sight information that is related to a line of sight of the user;
an emotion information acquisition means which acquires emotion information that is related to an emotion of the user; and
a relevance information output means that outputs information indicating relevance between a change in the task information, a change in the line-of-sight information, and a change in the emotion information, which are associated with a progress of the task.

### Additional Remark 3

Some of or all of the foregoing example embodiments can further be expressed as below.

An information processing system including at least one processor, the processor carrying out: a task information acquisition process which acquires task information that is related to a task carried out by a user in a virtual space; a line-of-sight information acquisition process which acquires line-of-sight information that is related to a line of sight of the user; an emotion information acquisition process which acquires emotion information that is related to an emotion of the user; and a relevance information output process that outputs information indicating relevance between a change in the task information, a change in the line-of-sight information, and a change in the emotion information, which are associated with a progress of the task.

Note that this information processing system can further include a memory, and in this memory, a program for causing the processor to carry out the task information acquisition process, the line-of-sight information acquisition process, the emotion information acquisition process, and the relevance information output process can be stored. Further, the program can be stored in a non-transitory tangible storage medium that can be read by a computer.

### REFERENCE SIGNS LIST

1, 1A, 1B information processing system
10A, 10B server
20 HMD
30 operation device
40, 250 sensor
50 terminal
110A, 110B, 210, 510 control unit
120A, 120B, 220, 520 storage unit
130A, 130B, 230, 530 communication unit
11, 11A, 11B task information acquisition unit
12, 12A, 12B line-of-sight information acquisition unit
13, 13A, 13B emotion information acquisition unit
14, 14A, 14B relevance information output unit
15A, 15B content execution unit
16B moving image generation unit
240, 540 display unit
550 input unit
C1 processor
C2 memory

What is claimed is:

1. An information processing system comprising at least one processor,
the at least one processer carrying out:
a task information acquisition process for acquiring task information that is related to a task carried out by a user in a virtual space;
a line-of-sight information acquisition process for acquiring line-of-sight information that is related to a line of sight of the user;
an emotion information acquisition process for acquiring emotion information that is related to an emotion of the user; and
a relevance information output process for outputting information indicating relevance between a change in the task information, a change in the line-of-sight information, and a change in the emotion information, which are associated with a progress of the task.

2. The information processing system according to claim 1, wherein the emotion information includes information indicating a magnitude of a predetermined emotion.

3. The information processing system according to claim 1, wherein the line-of-sight information includes information indicating a virtual object disposed on the line of sight in the virtual space.

4. The information processing system according to claim 1, wherein the task information includes information indicating a degree of appropriateness of an operation associated with the task, or start, end, or type of the task.

5. The information processing system according to claim 1, wherein
in the relevance information output process, the at least one processor outputs, as the information indicating the relevance, information including
a graph that indicates the change in the emotion information with respect to an elapsed time of the task, and
the task information or the line-of-sight information that was acquired at any elapsed time point indicated in the graph.

6. The information processing system according to claim 1, wherein
in the relevance information output process, the at least one processor outputs, as the information indicating the relevance, information including
a moving image in which an image of the progress of the task is captured by a virtual camera disposed in the virtual space, and
the task information, the emotion information, or the line-of-sight information that was acquired at any elapsed time point of the task corresponding to any reproduction position of the moving image.

7. The information processing system according to claim 1, wherein:
in the relevance information output process, the at least one processor outputs, to the virtual space in which the progress of the task carried out in the past is being replicated, the information indicating the relevance; and
the information indicating the relevance indicates relevance between a change in the task information, a change in the emotion information and a change in the line-of-sight information, which were acquired when the task being currently replicated was carried out in the past.

8. The information processing system according to claim 1, wherein:
in the relevance information output process, the at least one processor outputs, to the virtual space in which the user is carrying out the task, the information indicating the relevance; and
the information indicating the relevance indicates relevance between a change in the task information, a change in the emotion information, and a change in the line-of-sight information, which were acquired when a task identical to the task was carried out in the past.

9. The information processing system according to claim 1, wherein:
the at least one processor further carries out a virtual space generation process for generating the virtual space; and
in the virtual space generation process, the at least one processor generates the virtual space that allows the task to be carried out therein again in a case where information that gives an instruction to carry out the task again is inputted in response to output of the information indicating the relevance.

10. The information processing system according to claim 1, wherein
in the relevance information output process, the at least one processor outputs, as the information indicating the relevance, information that satisfies a condition related to at least one selected from the group consisting of the task information, the line-of-sight information, the emotion information, and the user.

11. The information processing system according to claim 1, wherein:
the task information includes the task information that is related to a plurality of users;
the emotion information includes the emotion information that is related to the plurality of users;
the line-of-sight information includes the line-of-sight information that is related to the plurality of users; and
in the relevance information output process, the at least one processor outputs, in a comparable manner, the information that indicates the relevance and that is related to each of the users.

12. The information processing system according to claim 1, wherein:
in the relevance information output process, the at least one processor outputs, as the information indicating the relevance, information including the task information or the line-of-sight information which was acquired at an elapsed time point at which the change in the emotion information associated with the progress of the task is larger than changes in the emotion information before and after the change in the emotion information.

13. The information processing system according to claim 1, wherein:
in the relevance information output process, the at least one processor outputs, as the information indicating the relevance, information including information indicating a cause due to which the change in the emotion information associated with the progress of the task is larger than changes in the emotion information before and after the change in the emotion information.

14. An information processing method, comprising:
acquiring, by at least one processor, task information that is related to a task carried out by a user in a virtual space;
acquiring, by the at least one processor, line-of-sight information that is related to a line of sight of the user;
acquiring, by the at least one processor, emotion information that is related to an emotion of the user; and
outputting, by the at least one processor, information indicating relevance between a change in the task information, a change in the line-of-sight information, and a change in the emotion information, which are associated with a progress of the task.

15. A non-transitory storage medium storing a program for causing a computer to carry out:
a task information acquisition process for acquiring task information that is related to a task carried out by a user in a virtual space;
a line-of-sight information acquisition process for acquiring line-of-sight information that is related to a line of sight of the user;
an emotion information acquisition process for acquiring emotion information that is related to an emotion of the user; and
a relevance information output process for outputting information indicating relevance between a change in the task information, a change in the line-of-sight information, and a change in the emotion information, which are associated with a progress of the task.
